(19) United States
(12) Patent Application Publication
(10) Pub. No.: US 2025/0321995 A1
(43) Pub. Date: Oct. 16, 2025

(54) PERMISSION-BASED AI SYSTEM RESPONSES

(71) Applicant: Jive Software, LLC, Austin, TX (US)

(72) Inventors: Sandesh Jain, Delhi (IN); Utsav Chokshi, Bengaluru (IN); Bilal Afzal, Islamabad (PK); Rahul Subramaniam, Chennai (IN); Greg Coyle, Charlottesville, VA (US); Ankush Pandey, Lucknow (IN)

(73) Assignee: Jive Software, LLC, Austin, TX (US)

(21) Appl. No.: 19/177,469

(22) Filed: Apr. 11, 2025

Related U.S. Application Data
(60) Provisional application No. 63/632,983, filed on Apr. 11, 2024.

(51) Int. Cl. G06F 16/3329; G06F 16/334; G06F 21/62; G06F 40/30

(52) U.S. Cl. CPC G06F 16/33295; G06F 16/3344; G06F 21/6209; G06F 40/30; G06F 2221/2141

(57) ABSTRACT

A method and apparatus are disclosed for generating permission-based large language model responses by using a query received from a user to identify a plurality of documents that are semantically similar to the query, using an access token received from the user to identify user accessible documents from the plurality of documents that the user is permitted to access, processing the user accessible documents to define a context of user accessible documents that is associated with the query, and then submitting the query and the context of user accessible documents to a large language model (AI system) to generate an AI system response to the query.

### CROSS-REFERENCE TO RELATED APPLICATION

This application claims the benefit under 35 U.S.C. § 119(e) and 37 C.F.R. § 1.78 of U.S. Provisional Application No. 63/632,983, filed Apr. 11, 2024, which is incorporated by reference in its entirety.

### BACKGROUND

### Field of the Invention

The present disclosure is directed in general to the field of information processing. In one aspect, the present disclosure relates generally to an information processing system, computer program code, method, and apparatus for using an AI system to generate one or more responses to user-submitted questions.

### Description of the Related Art

In the field of artificial intelligence (AI), AI systems generally utilize language models, such as large language models (LLM) or small language models (SLM), are used to perform a to respond to input prompts, such as natural language questions, engineered prompts, or other prompts. The AI system is trained on knowledge acquired from massive datasets of, for example, text documents during a computationally intensive supervised training process. More specifically, AI system use a particular neural network architecture called a transformer, which is designed to process and generate data in sequence, like text, so that the AI system can recognize, translate, predict, or generate text or other content.

To train an AI system, a pre-training phase may use an input dataset of text documents as an initial operation to train the model to function as a next word predictor. In this pre-training operation, a large and diverse document dataset is gathered from the internet or other data source, processed to remove noise, formatting issues, and irrelevant information, and then tokenized into smaller units which may be transformed to train the model of the AI system to predict the next word in a sequence of text. After pre-training, a supervised tuning process is applied whereby a (typically) human trainer provides target responses to user inputs so that the model learns to generate responses by minimizing the difference between its predictions and the provided responses. In addition, reinforcement learning from human feedback may be applied as a second fine-tuning operation to align the model with human preferences.

Conventional approaches for training an AI system will use all available information from the input document dataset, with the objective being to provide the best AI system responses based on the broadest collection of input information.

Data systems have acceptable mechanisms to regulate access and, thus, protect sensitive information, such as personally identifiable information (PII), trade secrets, etc., from disclosure to unauthorized individuals. Existing permission-based data access control mechanisms regulate who can access particular data in a digital system.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 is a simplified block diagram of an information processing system for generating and using an AI system to provide responses to user queries that are aligned with the permission access of the user.

FIG. 2 illustrates a message flow signaling sequence during operation of an AI system for generating responses to user queries that are aligned with the permission access.

FIG. 3 is a simplified block diagram of a processor and components of an information processing system which may be used in an AI system for generating responses to user queries that are aligned with the permission access.

### DETAILED DESCRIPTION

Although conventional data systems have acceptable mechanisms to regulate access and, thus, protect sensitive information, these mechanisms do not apply to AI systems. A technical problem exists in that traditional role-based access control mechanisms cannot be enabled when interacting with AI systems. AI systems have access to and, thus, are trained on an immense amount of data including sensitive data. However, queries to AI systems can inadvertently reveal sensitive information. For example, if an AI system is trained on an entity's engineering data, trade secrets in the engineering data may be revealed by the AI system in response to a prompt.

A permission-based AI system and method of operating the AI system generate responses to user queries that are aligned with the permission access of the user by limiting the knowledge base provided to an AI system generator to include only documents which the requestor is authorized to access. In at least one embodiment, the permission-based AI system generates a response to a user query submitted in an input prompt from a user, such as user queries received via a user interface (UI), by identifying a knowledge base of ingested content that is relevant to the user query. The AI system identifies and checks user access permissions to a knowledge base from which the response is generated and then submits the user query and permission-based knowledge base to an AI system generator. The AI system generator generates a response to the user query by constructing a language model from the permission-based knowledge base. In this way, the AI system generator of the AI system provides a technical solution to the technical problem by constraining generated responses to responses restricted to data within the user's data permission access.

In selected embodiments, a user/requestor uses a first computer system to submit a query and associated user access token to a query handling system, such as by using a browser extension which formats and transmits the query and user access token to the query handling system at a second computer system. At the second computer system, the query is processed and transmitted to a vector store to retrieve similar documents, such as by using a k-Nearest Neighbor (kNN) algorithm to select k documents from the vector store that are closest to the query. In addition, the second computer system processes and transmits the user access token to an access database to determine which documents the user/requester is authorized to access, such as by using an entitlement API to retrieve document IDs for documents the user/requestor is authorized to access. In addition, the second computer system saves, as a context for an AI system submission, a predetermined number of top documents that the user/requester is authorized to access that will fit within any applicable context constraint. Subsequently, the second computer system formats and transmits an AI system prompt (along with the query and context) to a third computer system which generates an AI system answer, such as by using any suitable OpenAI Generative Pre-trained Transformer (GPT) model to generate an answer from the AI system based on the submitted query and context.

The permission-based AI system and method set forth herein address technical issues with generating the desired outputs described herein. Conventionally, manual processes were used to generate the desired outputs and were very tedious and time consuming. The present permission-based AI system and method utilize an automated system that does not merely automate a manual process or use a conventional system in a conventional way. The present permission-based AI system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system to solve the problems below presents a technical problem that requires a technical solution. The permission-based AI system and method described below are not simply engaging a computer to carry out conventional mental processes, but rather change how computers (and AI systems, specifically) operate to achieve the generation results that were not previously possible or were substantially inefficient prior to the permission-based AI system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

While various details are set forth in the following description, it will be appreciated that the present disclosure may be practiced without these specific details. For example, selected aspects are shown in block diagram form, rather than in detail, in order to avoid obscuring the present disclosure. Some portions of the detailed descriptions provided herein are presented in terms of algorithms or operations on data within a computer memory. Such descriptions and representations are used by those skilled in the data processing arts to describe and convey the substance of their work to others skilled in the art. In general, an algorithm refers to a self-consistent sequence of operations leading to a desired result, where a “operation” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that throughout the description, discussions using terms such as processing, computing, calculating, determining, displaying or the like, refer to the action and processes of a computer system, or similar electronic computing device, that manipulates and/or transforms data represented as physical, electronic and/or magnetic quantities within the computer system's registers and memories into other data similarly represented as physical quantities within the computer system memories or registers or other such information storage, transmission or display devices.

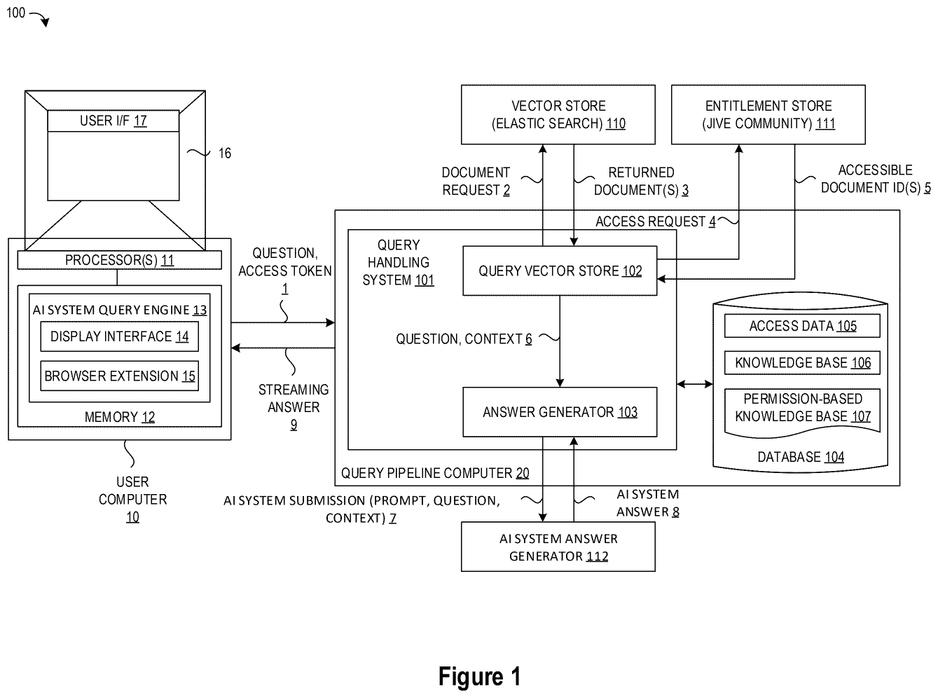

Referring now to FIG. 1, a simplified block diagram illustrates an exemplary permission-based AI system 100 for generating and using an AI system to provide responses to user queries that are aligned with the permission access. Generally speaking, the system 100 includes a first user server/computer system 10 which receives and submits user questions and also displays AI system-based answers. In addition, the system 100 includes a second query pipeline server/computer system 20 which generates the AI system-based answers by identifying a permission-based knowledge base of ingested content that is relevant to the user questions and submitting the user question and permission-based knowledge base to an AI system answer generator 112 which generates an answer to the user question by constructing a language model from the permission-based knowledge base.

In selected embodiments, the first user server/computer system 10 may include one or more processors 11, a memory 12, a display screen 16 and one or more associated input/output devices (not shown) that are connected and configured to receive and submit user questions to the second query pipeline server/computer system 20. To illustrate the operative functionality of the first user server/computer system 10, the memory 12 may store computer program code which provides functionality for the AI system query engine 13. As described hereinbelow, the AI system query engine 13 includes a display interface module 14 which receives a query from a logged-in user using the input/output devices, and which processes a received answer 9 for display on the user interface 17 of the display screen 16. In addition, the AI system query engine 13 may include a browser extension module 15 which receives a user extension request and the user question from the display interface module 14, and which transmits a query message 1 to the second query pipeline server/computer system 20 which includes the user question and an access token. As disclosed herein, the access token identifies the user, and may be retrieved from the access data 105 stored in the database 104. The operation of the AI system query engine 13 to transform the user question and access token for transmission in the query message 1 may be implemented with any suitable browser extension format (e.g., Chrome extension), though it will be appreciated that the user question and an access token may also be stored in the memory 12 and/or retrieved from a database (not shown) at the user computer 10.

In selected embodiments, the second query pipeline server/computer system 20 may include a query handling system 101 and a database 104 that are connected and configured to identify a knowledge base 106 of ingested content that is relevant to the user question, to check user access permissions for the knowledge base to identify a permission-based knowledge base 107, and to submit the user question and permission-based knowledge base to an AI system answer generator 112 that generates a response to the user question by constructing a language model from the permission-based knowledge base. Though not shown, it will be appreciated that the second query pipeline server/computer system 20 may have one or more processors connected to a memory which stores computer program code which provides functionality for the query handling system 101. In particular, the query handling system 101 includes a query vector store module 102 which is configured to generate a request for documents based on the user question contained in the query message 1, to transmit a document request message 2 with the document request to the vector store 110, and to receive a returned documents message 3 with one or more returned documents identified by the vector store 110.

In selected embodiments, the query vector store module 102 generates the document request message 2 to include a vector representation of the user question which is transmitted to the vector store 110 which uses a k-Nearest Neighbor (kNN) algorithm to select k documents from the vector store 110 that are closest to the vector representation of the user question. For example, the document request message 2 may request the top k=25 semantically similar documents or data chunks that most closely match the user question, though the number of documents or data chunks can vary and/or can be specified in the document request message 2.

To process the document request message 2, the vector store 110 may include embeddings representing documents or data chunks that are ingested, and these embedding are compared to the vector representation of the user question to identify at least the k closest documents or data chunks which are included in the returned documents message 3. Any suitable vector search tool may be used to implement the document return functionality of the vector store 110, including but not limited to Elastic Search, Pinecone, Milvus, Chroma, Weaviate, or Takeway. For example, Elastic search is a popular open-source search and analytics engine built on Apache Lucene that is designed for full-text search, analytics, and log analytics use cases. Using an inverted index to quickly locate documents that contain the searched terms, Elastic Search is accessible via REST APIs. Whichever vector search tool is used, the returned documents contained in the returned documents message 3 may be stored as the preliminary or initial knowledge base 106 in the database 104. In selected embodiments, the vector store 110 may identify the k+15 closest documents or data chunks which have a minimum similarity score (e.g., at least 0.5).

In addition, the query vector store module 102 generates the access request message 4 which is transmitted to the entitlement store 111 which identifies which of the returned documents or data chunks the user has permission to access. For example, the access request message 4 may include a batch and content entitlement API which uses the access token from the query message 1 to request a listing of documents or data chunks that the user is permitted to access. Instead of offering a direct API to retrieve user access/permission information for all documents or data chunks in the vector store 110, the batch and content entitlement API submits the access request message 4 to the entitlement store 111 which is structured to quickly and efficiently provide an accessible document ID message 5 which lists IDs for the document(s) or data chunk(s) which the user is permitted to access. As will be appreciated, any suitable user document identification tool may be used to implement the identification of user accessible documents of the entitlement store 111, including but not limited to the Jive Copilot Community tool which tracks user access entitlements or permissions for each document or chunk collected from the entire Jive community of registered users. Upon receiving the accessible document ID message 5, the query vector store module 102 uses this information to determine which of the returned documents are user accessible documents/data chunks. The user accessible documents/data chunks may be stored as the permission-based knowledge base 107 in the database 104.

In addition, the query vector store module 102 may be configured to determine how many of the user accessible documents/data chunks can fit within any within any applicable context window constraint that is required by the AI system answer generator 112 before sending the user question and associated context in an internal message 6 to the answer generator module 103. For example, there is a 16K limit on the size of any context submitted to the OpenAI GPT 3.5 Turbo model. In selected embodiments, the query vector store module 102 may also be configured to identify and store a predetermined number of the user accessible documents/data chunks as the context that is associated with the user question. For example, the query vector store module 102 may select the top 10 user accessible documents/data chunks as the context that will be submitted to the OpenAI GPT 3.5 Turbo model.

As disclosed herein, the query handling system 101 also includes an answer generator module 103 which is configured to generate and transmit an AI system submission message 7 to the AI system answer generator 112 which generates and returns an AI system answer message 8 which may be streamed back to the answer generator module 103. For example, the AI system submission message 7 may include a prompt, the user question, and the context formed from the user accessible documents/data chunks. As will be appreciated by those skilled in the art, the OpenAI GPT 3.5 AI system includes a context feature (a.k.a., “custom instructions”) that gives users the ability to add a general context that ChatGPT will use as a part of its evaluation every time it answers a question or is given instructions. In particular, the AI system answer generator 112 uses the user question and context to prompt the AI system, which is a neural architecture that is designed to predict the next token or word in a sequence of tokens or words, where the prediction is based on the previous sequence of tokens or words that is provided to the model (the context or prompt). By predicting the next word or token, adding it to the context and then making a subsequent prediction with the augmented context, the AI system generator 112 can generate an answer to the user question. An example of an AI system is GPT 3.5 which has 175 billion parameters and has been trained on approximately 45 terabytes of text. Large language models have the helpful property, particularly if so trained, of being able to be instructed in the context (or “prompt”) and the text they then generate extending the context thus often obeys that instruction and can answer general questions or do a variety of different tasks typically previously seen in the text they have been trained on. Useful behaviors can thus be delivered by these models simply by creating a suitable prompt. In some cases, models that have been trained on huge amounts of general text can be further improved by fine tuning the model on text that contains many examples of the desired task. Small numbers of examples can also be included in the prompt.

In response to the AI system answer message 8, the answer generator module 103 may be configured to process the AI system answer for transmission as a streaming answer message 9 to the first user computer 10. At the AI system query engine 13 of the user computer 10, the browser extension module 15 is configured to receive the streaming answer message 9 where it is forwarded to the display interface module 14 for display on the user interface 17 of the display screen 16. While there may be small latency imposed by adding messaging requirements for generating a context based on the permission-based knowledge base, this typical latency is approximately 1 second, and results in a query handling system 101 where the user questions are consistently provided with a context of relevant documents or data chunks that are permitted for user access to improve the answer performance of the AI system without making any actual upgrades to the AI system itself.

As will be appreciated, once the server/computer system 10 is configured to implement the AI system query engine 13, the server/computer system 10 becomes a specialized computing device specifically configured to implement the mechanisms of the illustrative embodiments, and is not a general purpose computing device. In similar fashion, once the query pipeline server/computer system 20 is configured to implement the query handling system 101, it becomes a specialized computing device specifically configured to implement the mechanisms of the illustrative embodiments, Moreover, as described hereafter, the implementation of the mechanisms of the illustrative embodiments improves the functionality of the computing device and provides a useful and concrete result that facilitates the generation of AI system answers to user-submitted questions by generating an AI system submission which includes the user question along with a context formed from the user accessible documents/data chunks, thereby improving the question-answer performance of the AI system.

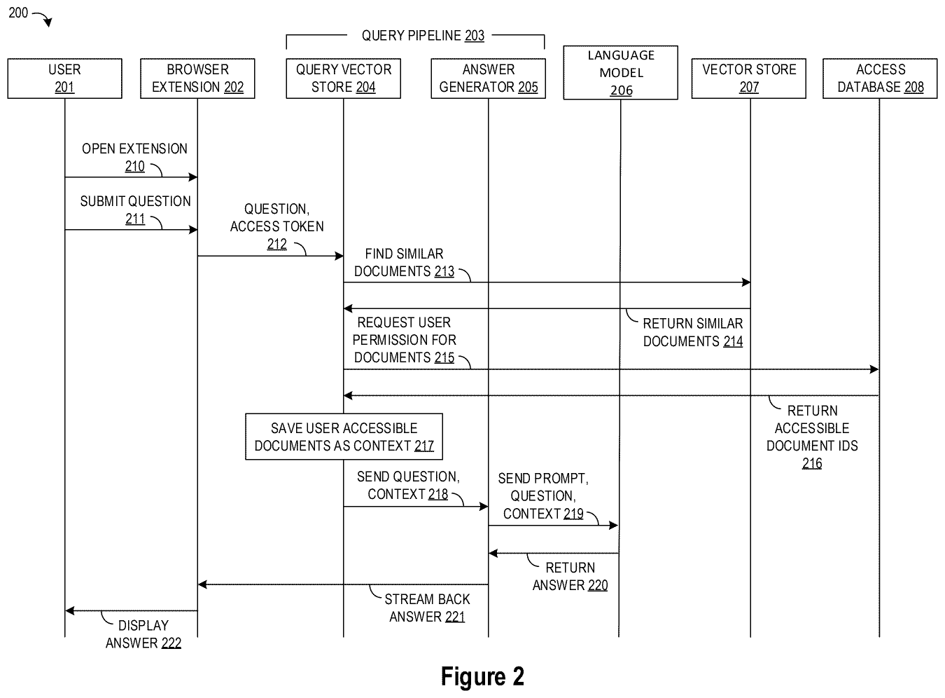

To provide additional details for an improved understanding of selected embodiments of the present disclosure, reference is now made to FIG. 2 which diagrammatically illustrates a message flow signaling sequence 200 during operation of a large language model system for generating responses to user queries that are aligned with the permission access of the user.

In the depicted signaling sequence, a user 201 sends a request to open an extension 210 to a browser extension 202. In addition, the user 210 sends a question submission message 211 to the browser extension 202. As disclosed herein, the browser extension 202 may be embodied with a Jive Copilot Chrome extension that is installed at the user server/computer device.

In response to the open extension request 210, the browser extension 202 assembles and processes a query request message 212 with the submitted question and an access token for transmission to the query vector store 204 at the query pipeline 203. As disclosed herein, the access token identifies the user 201.

In response to the query request message 212, the query vector store 204 issues a request message 213 to the vector store 207 to find similar documents. As disclosed herein, the request message 213 may include a vector representation of the user question and a request to perform a KNN search of the query vector store 204.

In response to the request message 213, the vector store 207 identifies a predetermined number of semantically similar documents which have a minimum similarity score with the vector representation of the user question, and then sends the identified similar documents in a return message 214 to the query vector store 204. In such embodiments, the vector store 207 may be configured to periodically ingest documents or chunks from an entire community of users (e.g., a Jive Community), regardless of user permissions, and then create a set of embedding vectors that are stored in a database. In order to find documents or chunks that are semantically similar to the user question, the vectors store 207 may also include an Elastic Search vector search tool, though any suitable vector search tool may be used to implement the document return functionality of the vector store 207.

In response to the return message 214, the query vector store 204 issues a request message 215 to the access database 208 to identify which documents or chunks the user is permitted to access. As disclosed herein, the request message 215 may use an entitlement API to check user access to all the semantically similar documents or chunks using a Jive batch API request and Jive content entitlement API at the query time.

In response to the request message 215, the access database 208 identifies which of the semantically similar documents the user is permitted to access, and then sends the requested information in a return message 216 to the query vector store 204. As disclosed herein, the return message 216 may list document IDs for the document(s) or data chunk(s) which the user is permitted to access.

In response to the return message 216, the query vector store 204 saves the user accessible documents/data chunks identified by the accessible document IDs as a context for the user question at operation 217. As disclosed herein, the processing of the user accessible documents/data chunks may include processing operations to select and fit the user accessible documents/data chunks to meet any applicable context requirements. For example, the query vector store 204 may determine how many of the user accessible documents/data chunks fit within a size constraint window for the AI system answer generator 205. In addition or in the alternative, the query vector store 204 may also be configured to identify and store a predetermined number of the user accessible documents/data chunks as the context that is associated with the user question.

Once the context is created, the query vector store 204 sends an answer request message 218 containing the user question and context to the answer generator 205. In response to the answer request message 218, the answer generator 205 transmits an AI system prompt message 219 which includes the user question and context to the AI system 206 to request an AI system answer.

In response to the AI system prompt message 219, the AI system 206 generates a response or answer to the user question which is guided by the context. As disclosed herein, the AI system 206 may be implemented with any suitable language model, such as the OpenAI GPT model (e.g., GPT 3.5 Turbo, GPT 4.0, etc.) to generate an answer from the AI system based on the submitted query and context.

The AI system 206 then sends a return answer message 220 to the answer generator, such as by streaming back the AI system answer. In response to the return answer message 220, the answer generator 205 relays the AI system answer to the user by sending a stream back answer message 221 to the browser extension 202.

In response to the stream back answer message 221, the browser extension 202 assembles and processes the AI system answer by displaying the answer 222 to the user 201.

As depicted, the vector store 207 and access database 208 are each separately configured to perform their respective processing operations in an efficient manner, but it will be appreciated that the vector store 207 and access database 208 could also be consolidated into a single database or computer storage device so that a single request message from the query vector store 204 could be used to identify the user accessible documents/data chunks. In similar fashion, the query vector store 204 and answer generator 205 could also be consolidated into a single query pipeline module which is configured to query one or more database or computer storage devices to identify the user accessible documents/data chunks.

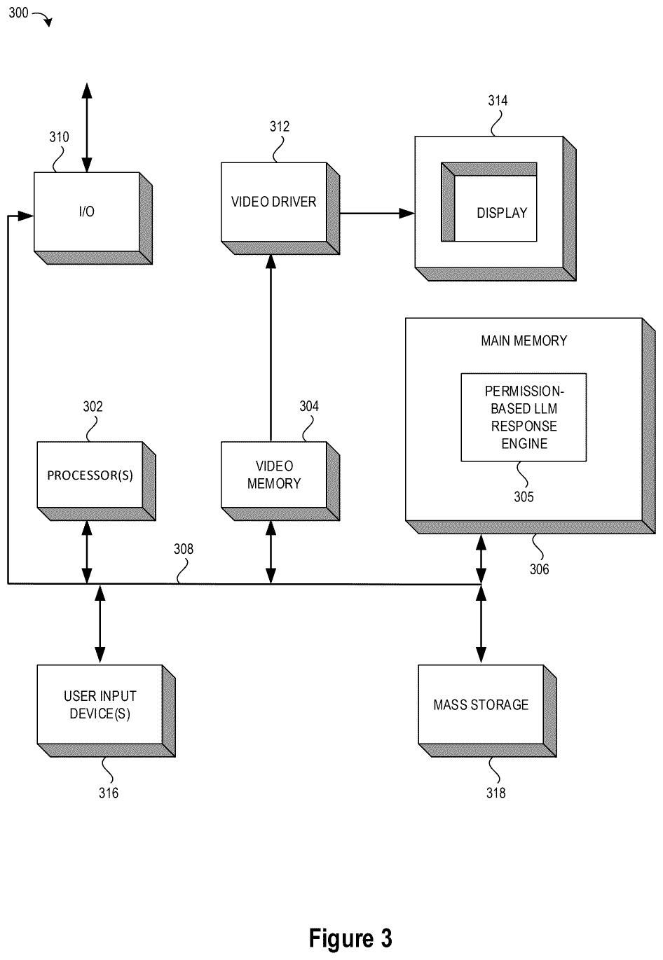

Embodiments of the permission based system 100 and method 200 for using a large language model (AI system) to generate responses to user queries that are aligned with the permission access of the user by can be implemented on a computer system, such as the information processing system 300 illustrated in FIG. 3. As disclosed, the information processing system 300 includes input user device(s) 316, such as a keyboard and/or mouse, which are coupled to a bi-directional system bus 308. The input user device(s) 316 are used for introducing user input to the information processing system 300 and communicating that user input to one or more processors 302. The information processing system 300 may also include a video memory 304, main memory 306, and mass storage 318, all coupled to bi-directional system bus 308 along with input user device(s) 316 and processor(s) 302. The mass storage 318 may include both fixed and removable media, such as other available mass storage technology. Bus 308 may contain, for example, 32 address lines for addressing video memory 304 or main memory 306. The system bus 308 may also include, for example, an n-bit data bus for transferring data between and among the components, such as CPU 302, main memory 306, video memory 314, and mass storage 318, where “n” is, for example, 32 or 64. Alternatively, multiplex data/address lines may be used instead of separate data and address lines.

The information processing system 300 may also include I/O device(s) 310 which provide connections to peripheral devices, such as a printer, and may also provide a direct connection to remote server computer systems via a telephone link or to the Internet via an ISP. I/O device(s) 310 may also include a network interface device to provide a direct connection to remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as instructions and data in mass storage 318 until loaded into main memory 306 for execution. Computer programs may also be in the form of electronic signals modulated in accordance with the computer program and data communication technology when transferred via a network. The method and functions relating to system and method for generating AI system responses to user queries that are aligned with the permission access of the user may be implemented in a computer program for a permission-based AI system response engine 305 which restricts the user's permission access to a knowledge base of documents/data chunks that are used to form the context for an AI system prompt or request.

The processor 302, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 306 is comprised of dynamic random access memory (DRAM). Video memory 304 is a dual-ported video random access memory. One port of the video memory 304 is coupled to video amplifier or driver 312. The video amplifier 312 is used to drive the display 314. Video amplifier 312 is well known in the art and may be implemented by any suitable means. This circuitry converts pixel data stored in video memory 304 to a raster signal suitable for use by display 314. Display 314 is a type of monitor suitable for displaying graphic images.

By now, it will be appreciated that there is disclosed herein a system, method, apparatus, computer program product, and device for generating permission-based large language model responses. As disclosed, the device receives a user query and an access token identifying a user that submitted the user query. In selected embodiments, the user query and the access token received by the device are submitted by a user through a browser extension on a user computer device. In addition, the device identifies a plurality of documents or data chunks that are semantically similar to the user query. In selected embodiments, the device identifies the plurality of documents by requesting that a vector store use a k-Nearest Neighbor (kNN) search to retrieve the plurality of documents that are semantically similar to the user query. In such embodiments, the vector store may perform a kNN search of a set of embedding vectors that are stored in the vector store to find the plurality of documents that are semantically similar to a vector representation of the user query. The device also identifies one or more user accessible documents from the plurality of documents that the user is permitted to access based on the access token. In selected embodiments, the device identifies the one or more user accessible documents by requesting that an access database identify one or more document IDs for any of the plurality of documents that the user is permitted to access. In addition, the device processes the one or more user accessible documents to define a context of user accessible documents that is associated with the user query. In selected embodiments, the device processes the one or more user accessible documents selecting a subset of the one or more user accessible documents that fit within a defined constraint size limit for the AI system. In other embodiments, the device processes the one or more user accessible documents by selecting a predetermined number of the one or more user accessible documents that fit within a defined constraint size limit for the AI system. The device also submits the user query and the context of user accessible documents to a large language model (AI system) to generate an AI system response to the user query. In addition, the device receives the AI system response generated by the AI system, and then forwards the AI system response to the user for display. In selected embodiments, the device submits the user query and the context of user accessible documents to an OpenAI Generative Pre-trained Transformer (GPT) AI system.

The permission-based system and method and non-transitory, computer program code stored on a non-transitory medium may be executed by one or more processors of a computer that is specialized with the code to allow the system to restrict AI system responses to responses to a user based on data to which the user is permitted access. The software discussed herein may include script, batch, or other executable files. In one embodiment, the software uses a local or database memory to implement the data transformation and data structures so as to automatically constrain, limit, or filter the knowledge base of documents/data chunks that are semantically similar to a user query when forming an AI system context submission, thereby improving the quality and robustness of answers generated by an AI system answer generator. The memory used for storing firmware or hardware modules in accordance with an embodiment of the disclosure may also include a semiconductor-based memory, which may be permanently, removably or remotely coupled to a microprocessor system. Other new and various types of computer-readable storage media may be used to store the modules discussed herein. Additionally, those skilled in the art will recognize that the separation of functionality into modules is for illustrative purposes. Alternative embodiments may merge the functionality of multiple software modules into a single module or may impose an alternate decomposition of functionality of modules. For example, a software module for calling sub-modules may be decomposed so that each sub-module performs its function and passes control directly to another sub-module.

In addition, selected aspects of the permission-based system and method may take the form of an entirely hardware embodiment, an entirely software embodiment (including firmware, resident software, micro-code, etc.), or an embodiment combining software and/or hardware aspects that may all generally be referred to herein as a “circuit,” “module” or “system.” Furthermore, aspects of the permission-based system and method may take the form of computer program product embodied in a computer readable storage medium or media having computer readable program instructions thereon for causing one or more processors to carry out aspects of the present disclosure. Thus embodied, the disclosed system, a method, and/or a computer program product is operative to improve the design, functionality and performance of an AI system answer generator by automatically constraining, limiting, or filtering the knowledge base of documents/data chunks that are semantically similar to a user query when forming an AI system context submission.

Computer readable program instructions described herein can be downloaded to respective computing/processing devices from a computer readable storage medium or to an external computer or external storage device via a network, for example, the Internet, a Public Switched Circuit Network (PSTN), a packet-based network, a personal area network (PAN), a local area network (LAN), a wide area network (WAN), a wireless network, or any suitable combination thereof. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Visual Basic.net, Ruby, Smalltalk, C++ or the like, and conventional procedural programming languages, such as the “C” programming language, Hypertext Precursor (PHP), or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart and message sequence illustrations and/or block diagrams of methods, apparatus (systems), and computer program products according to embodiments of the disclosure. It will be understood that each block of the illustrations and/or block diagrams, and combinations of blocks in the illustrations and/or block diagrams, can be implemented by computer readable program instructions.

These computer readable program instructions may be provided to one or more processors of a computer system that is specialized to implement and perform the permission-based system and method. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a sub-system, module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The system and method for generating AI system responses to user queries that are aligned with the permission access of the user may be implemented on one or more stand-alone computer systems or from server computer systems system that can be accessed by a plurality of client computer systems interconnected over an intranet network.

What is claimed is:

1. A method performed by a device for generating permission-based artificial intelligence system responses, comprising:
receiving, by the device, a user query and an access token identifying a user that submitted the user query;
identifying, by the device, a plurality of documents that are semantically similar to the user query;
identifying, by the device, one or more user accessible documents from the plurality of documents that the user is permitted to access based on the access token;
processing, by the device, the one or more user accessible documents to define a context of user accessible documents that is associated with the user query;
submitting, by the device, the user query and the context of user accessible documents to the AI system to generate an AI system response to the user query;
receiving, by the device, the AI system generated response; and
forwarding, by the device, the AI system response to the user for display.

2. The method of claim 1, receiving the user query and the access token comprises receiving the user query and the access token that is submitted by a user through a browser extension on a user computer device.

3. The method of claim 1, where identifying the plurality of documents comprises requesting that a vector store use a k-Nearest Neighbor (kNN) search to retrieve the plurality of documents that are semantically similar to the user query.

4. The method of claim 3, where the vector store performs a kNN search of a set of embedding vectors that are stored in the vector store to find the plurality of documents that are semantically similar to a vector representation of the user query.

5. The method of claim 1, where identifying the one or more user accessible documents comprises requesting that an access database identify one or more document IDs for any of the plurality of documents that the user is permitted to access.

6. The method of claim 1, where processing the one or more user accessible documents comprises selecting a subset of the one or more user accessible documents that fit within a defined constraint size limit for the AI system.

7. The method of claim 1, where processing the one or more user accessible documents comprises selecting a predetermined number of the one or more user accessible documents that fit within a defined constraint size limit for the AI system.

8. The method of claim 1, where submitting the user query and the context comprises submitting the user query and the context of user accessible documents to an OpenAI Generative Pre-trained Transformer (GPT) AI system.

9. A computer program product comprising at least one recordable medium having stored thereon executable instructions and data which, when executed by at least one processing device, cause the at least one processing device to:
receive a user query and an access token identifying a user that submitted the user query;
identify a plurality of documents that are semantically similar to the user query;
identify one or more user accessible documents from the plurality of documents that the user is permitted to access based on the access token;
process the one or more user accessible documents to define a context of user accessible documents that is associated with the user query;
submit the user query and the context of user accessible documents to a large language model (AI system) to generate an AI system response to the user query;
receive the AI system generated response; and
forward the AI system response to the user for display.

10. The computer program product of claim 9, wherein the computer readable program, when executed on the system, causes the at least one processing device to receive user query and the access token by receiving the user query and the access token that is submitted by a user through a browser extension on a user computer device.

11. The computer program product of claim 9, wherein the computer readable program, when executed on the system, causes the at least one processing device to identify the plurality of documents by requesting that a vector store use a k-Nearest Neighbor (kNN) search to retrieve the plurality of documents that are semantically similar to the user query.

12. The computer program product of claim 11, where the vector store performs a kNN search of a set of embedding vectors that are stored in the vector store to find the plurality of documents that are semantically similar to a vector representation of the user query.

13. The computer program product of claim 9, wherein the computer readable program, when executed on the system, causes the at least one processing device to identify the one or more user accessible documents by requesting that an access database identify one or more document IDs for any of the plurality of documents that the user is permitted to access.

14. The computer program product of claim 11, where the computer readable program, when executed on the system, causes the at least one processing device to process the one or more user accessible documents by selecting a subset of the one or more user accessible documents that fit within a defined constraint size limit for the AI system.

15. The computer program product of claim 9, wherein the computer readable program, when executed on the system, causes the at least one processing device to process the one or more user accessible documents by selecting a predetermined number of the one or more user accessible documents that fit within a defined constraint size limit for the AI system.

16. The computer program product of claim 9, wherein the computer readable program, when executed on the system, causes the at least one processing device to submit the user query and the context by submitting the user query and the context of user accessible documents to an OpenAI Generative Pre-trained Transformer (GPT) AI system.

17. A system comprising:
one or more processors;
a memory coupled to at least one of the processors; and
a set of instructions stored in the memory and executed by at least one of the processors to generate permission-based AI system responses by performing operations comprising:
receiving a user query and an access token identifying a user that submitted the user query;
identifying a plurality of documents that are semantically similar to the user query by requesting that a vector store use a k-Nearest Neighbor (kNN) search to retrieve the plurality of documents that are semantically similar to the user query;
identifying one or more user accessible documents from the plurality of documents that the user is permitted to access based on the access token by requesting that an access database identify one or more document IDs for any of the plurality of documents that the user is permitted to access;
processing the one or more user accessible documents to define a context of user accessible documents that is associated with the user query;
submitting the user query and the context of user accessible documents to an OpenAI Generative Pre-trained Transformer (GPT) AI system to generate an AI system response to the user query;
receiving the AI system response generated by the OpenAI GPT AI system; and
forwarding the AI system response to the user for display.

18. The system of claim 17, where the vector store performs a kNN search of a set of embedding vectors that are stored in the vector store to find the plurality of documents that are semantically similar to a vector representation of the user query.

19. The system of claim 17, where processing the one or more user accessible documents to define a context of user accessible documents that is associated with the user query comprises selecting a subset of the one or more user accessible documents that fit within a defined constraint size limit for the AI system.

20. The system of claim 17, where processing the one or more user accessible documents comprises selecting a predetermined number of the one or more user accessible documents that fit within a defined constraint size limit for the AI system.
